(19) United States
(12) Patent Application Publication
(10) Pub. No.: US 2008/0141056 A1
(43) Pub. Date: Jun. 12, 2008

(54) Asset, PoE and power supply, stack management controller

(76) Inventors: Shadi A. AbuGhazaleh, Oakdale, CT (US); Doug O'Connor, Richmond, RI (US); Joseph E. Dupuis, Ledvard, CT (US)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/987,556

(22) Filed: Nov. 30, 2007

Related U.S. Application Data
(60) Provisional application No. 60/861,730, filed on Nov. 30, 2006.

(51) Int. Cl. G06F 1/26; G06F 3/00

(52) U.S. Cl. 713/340; 710/8

(57) ABSTRACT

A command module is provided to couple and manage one or more patch panels having advanced features such as assets and/or PoE and/or power supply functions. The command module can query attached patch panels having additional capabilities, synchronize data, and act as an administrative server. The system and method can be provided for managing such patch panels via a communication path and/or protocol, such as a serial communication protocol or a serial communication path that is star topology (direct connect) or daisy chained, and managing a patch panel including an IP network connection, and through this Ethernet interface, all manner of active management is performed such that management resides in command module.

### REFERENCE TO RELATED APPLICATIONS

This application claims the benefit of U.S. Provisional Application No. 60/861,730, filed Nov. 30, 2006. Related subject matter is disclosed in U.S. patent application Ser. No. 11/414,548, filed May 1, 2006, which is a continuation of U.S. patent application Ser. No. 11/038,460, filed Jan. 21, 2005, which is a continuation-in-part of U.S. patent application Ser. No. 10/791,291, filed Mar. 3, 2004, now abandoned. Related subject matter is also disclosed in U.S. patent application Ser. No. 10/791,292, filed Mar. 3, 2004.

### FIELD OF THE INVENTION

The present invention relates to an Asset, Power over Ethernet (PoE) and power supply controller for a device, such as a patch panel device including advanced features for providing power and data collection while providing at least category 3, 5, 5e, 6 and/or higher (e.g. 6A or 7) and equivalent performance levels as required.

### BACKGROUND OF THE INVENTION

The convergence of telecom and datacom technologies, as well as the blurring distinction between the system side and the cabling system of networks is driving a continuous evolution of structured cabling. User expectations and dependence on local area network (LAN) performance is creating an expectation beyond operational speed and reliability to further include device tracking and system management. Currently, limited progress has been made in such areas due to the impact of proposed improvements upon operational speed. As hubs and switches deal in logical addresses and network maps, asset location and connection management is best addressed through the cabling system. Tracking through the infrastructure also allows for tracking the switches and switch ports themselves. Development of advancements therefore, must address several evolving system features and requirements such as the detection of connected devices, including the addition, removal and/or movement of such devices accessing the system and the provision of power to connected devices.

The movement of devices accessing the system is one of several considerations during improvement developments. As described in U.S. Pat. No. 6,350,148, issued Feb. 26, 2002, to Batolutti et al., the entire subject matter of which is incorporated herein by reference, many businesses have dedicated telecommunication systems that enable computers, telephones, facsimile machines and the like to communicate with each other through a private network, and communicate with remote locations via a telecommunications service provider. In most buildings, the dedicated telecommunications system is hard wired using telecommunication cables that are coupled to individual service ports throughout the building. The wires from the dedicated service ports typically extend throughout the building and terminate at a patching system that is used to interconnect the various telecommunication lines. The patching system is usually located within a telecommunications closet and is most often positioned on a mounting frame that includes a number of racks or patch panels to which each telecommunication line is terminated. The patch panels include a number of port assemblies, such as RJ-45 telecommunication connector ports, and each telecommunication line is terminated to the patch panel in an organized manner.

One example of device movement considerations as disclosed in the Batolutti patent includes assigning one or more employees their own computer network access number exchange so that the employee can interface with a company main frame computer or computer network. As employees or equipment are moved, patch cords in a typical telecommunications closet are rearranged and new positions are manually documented using either paper or computer based logs. However, technicians often neglect to update the arrangement log each time a change is made. To correct this, manual tracing of the patch cord must be performed which can be both time consuming and prone to further errors.

Detecting connected devices is another consideration during improvement development which is commonly required for security purposes in many applications. Details of several examples of such detection issues are disclosed in U.S. Pat. No. 5,406,260, issued Apr. 11, 1995, to Cummings et al., the entire subject matter of which is incorporated herein by reference. A number of device detection methods have been developed for guarding against the unauthorized removal of electronic equipment, including methods that require the actual physical attachment of a security cord to each piece of protected equipment or the attachment of non-removal tags to the equipment. However, these methods require rather expensive sensing devices and are not very practical in all cases. In the device detection method disclosed in the Cummings patent, an isolation power supply is used to provide a low current DC power signal to each communication link and thereafter, monitor a circuit loop created through a DC resistive termination between the communication link and a remote device. Any interruption between the communication link and the remote device, such as the removal of the device from the communication link, disrupts the circuit loop and triggers an alarm.

Additional methods of circuit loop device detection also include the sensing of a current loop that is physically coupled to the protected equipment. One such method is disclosed in U.S. Pat. No. 4,654,640, issued Mar. 31, 1987, to Carll et al., the entire subject matter of which is incorporated herein by reference. The Carll patent discloses a theft alarm system for use with a digital signal PBX telephone system which includes a number of electronic tethers connected to individual pieces of protected equipment, each tether including a pair of conductors which are connected to form a closed current loop via a series resistor and conductive foil adhesively bonded to the equipment. Once assembled, the resulting circuit loop can be used for device removal detection however the conductive foil which is bonded to the equipment may be carefully removed without any detection.

The Batolutti patent also referenced above, discloses yet another method of detection for patch panel connectors themselves. A patch panel, on which multiple mechanical sensors are mounted, serves to detect the presence or absence of a patch cord connector in a connector port on the panel and a computer controller connected to the multiple sensors may then be used to monitor changes in patch panel connections, such as when a connector is removed from a connector port. The detection, however, is limited to the mere absence or presence of a connector in a connector port.

Providing power to connected devices is yet another consideration during improvement development which can often include aspects of device detection as described above. Power applications, such as those found in power over ethernet technologies, allows IP telephones, wireless LAN Access Points and other appliances to receive power while also receiving data over existing LAN cabling without a need to modify ethernet infrastructure. Such technologies are described in IEEE802.3af, also known as Power over Ethernet, which outlines the designs of Ethernet power-sourcing equipment and powered terminals.

Various methods for providing power to remote devices are also disclosed in U.S. Pat. No. 6,218,930, issued Apr. 17, 2001, to Katzenberg et al., the entire subject matter of which is incorporated herein by reference. In one example of a power application technology, an initial detection step is used prior to a power application step. Prior to applying external power to a device, automatic detection of connected equipment is accomplished by delivering a low level current to the network interface and measuring a voltage drop in the return path. The measurement can have three states, including no voltage drop, a fixed level voltage drop or a varying level voltage drop. As disclosed in the Katzenberg patent, if no voltage drop is detected, then the remote equipment does not contain a DC resistive termination and this equipment is identified as unable to support remote power feed. If a fixed voltage level is detected, the remote equipment contains a DC resistive termination, such as a “bob smith” termination and this equipment is also identified as being unable to support remote power feed. If a varying voltage level is detected, this detection indicates the presence of a DC-DC switching supply in the remote equipment and this equipment is identified as being able to support remote power feed which is then provided.

The attempts to address device movement and detection, as well as attempts to address providing power to connected devices, typically fail to consider the communication performance degradation that such solutions can create. Where attempts to correct performance degradation have been made, the solutions have typically been limited to the relocation and manipulation of signal traces. Examples of such solutions are disclosed in U.S. Pat. No. 5,797,764, issued Aug. 25, 1998, to Coulombe et al., and in U.S. Pat. No. 5,673,009, issued Sep. 30, 1997, to Klas et al., the entire subject matter of each being incorporated herein by reference. The Coulombe patent discloses a printed circuit board electrically coupling a connector block and jack assembly within a patch panel. Each signal trace on the board is provided a compensation trace aligned either above or below the respective signal trace for an electromagnetic connection between traces sufficient to reduce crosstalk. Trace manipulation is also disclosed in the Klas patent, which discusses a printed circuit board on which crosstalk is eliminated through the relocation of adjacent traces. Equal and opposite signal source traces are placed adjacent to one another such that cumulative crosstalk is eliminated. Unfortunately, trace manipulation is not sufficient in every case to provide category 3, 5, 5e, 6 and/or higher and equivalent performance levels.

Still further examples of such solutions are disclosed in U.S. Pat. No. 6,443,777, issued Sep. 3, 2002, to McCurdy et al., and in U.S. Pat. No. 6,464,541, issued Oct. 15, 2002, to Hashim et al., the entire subject matter of each being incorporated herein by reference. The McCurdy patent discloses an inductive and capacitive crosstalk compensation technique incorporated into a communication connector (i.e. modular jack) which includes the relocation of contact wires and the addition of a printed wiring board for capacitive coupling. The contact wires are separated by a distance set to obtain an adequate level of inductive compensation coupling, and a capacitive coupling is provided by one or more printed circuit boards located in the plug body as the contact wires are displaced. The use of such printed wiring boards is also discussed in the Hashim patent, which discloses a two stage crosstalk compensation technique. In a first stage, a printed wiring board is provided for capacitive coupling as the contact wires are displaced, and in a second stage, a printed wiring board is provided having a number of inductive loops and carefully positioned comb traces. Although both the McCurdy and Hashim patents address crosstalk reductions at the connector position, each fails to address the performance degradation beyond the connector, including performance degradation that can be created due to additional active circuitry elements involved in providing advanced features.

Still further, a system and method is needed to manage the inclusion and control of these desired features, such as a patch panel with asset and/or PoE and/or a power supply, for performing tasks such as the detection of connected devices, including the addition, removal and/or movement of such devices accessing the system and the provision of power to connected devices. In doing so, communication paths and interface connections are required that satisfy desired performance standards.

Examples of patch panel feature control are described in U.S. Patent Publication No. 2006/0094291 to Caveney et al., the entire subject matter of which is incorporated herein by reference. The Caveney '291 reference describes a system and method for monitoring and reporting patch panel port-level cable connectivity, and uses a system wherein each patch panel includes a patch panel controller that independently determines cable connectivity at the patch panel, and which can communicate with and be controlled by a network management system. Such a manage system is described in U.S. Patent Publication No. 2006/0047800 to Caveney et al., the entire subject matter of which is incorporated herein by reference. The Caveney '800 reference describes a network management system that is coupled to a number of end user devices such as patch panels, via a network such that functions can be distributed where possible to intelligent network devices. The central NMS can then perform higher-level monitoring and control, including network management functions and distribution of new command and control parameters.

Still other references, such as U.S. Patent Publication No. 2005/0245127 to Nordin et al. and U.S. Patent Publication No. 2004/0073597 to Caveney et al., the entire subject matter of each being incorporated herein by reference, describe a powered communications patch panel having a management port to allow remote management of the patch panel via a network connection. In regard to power control, U.S. Patent Publication No. 2006/0181398 to Martich et al., the entire subject matter of which is incorporated herein by reference, describes a patch panel and power distribution system compliant with IEEE 802.3af and TIA/EIA 568B.1-6 standards. A controller is provided as a control module to be removable or detachably mounted to facilitate repairs and upgrades, and can be configured to control power application to devices in conformance with IEEE 802.3af and TLA/EIA 568B.1-6 standards. However, in each case, function control is limited and there is no provision of function control in regard to connectivity.

Accordingly, a need exists for a controller for a device such as an asset aware patch panel providing one or more advanced features.

### SUMMARY OF THE INVENTION

An object of exemplary embodiments of the present invention is to substantially solve the above and other problems, and provide a system and method for managing a patch panel providing one or more advanced features, such as a patch panel with asset and/or Power over Ethernet (PoE) and/or power supply features.

Another object of exemplary embodiments of the present invention is to provide a system and method for managing a patch panel providing one or more advanced features, and including a serial communication path that is star topology (direct connect) or daisy chained.

Another object of exemplary embodiments of the present invention is to provide a system and method for managing a patch panel providing one or more advanced features, and including an IP network connection, and through this Ethernet interface, all manner of active management is performed.

Another object of exemplary embodiments of the present invention is to provide a system and method to query the power supply and/or determine its available total power, and compare it to power being used in order to perform power management and administration. The system and method can trigger alarms or other indications when certain thresholds of power usage levels are reached. The controller can also instruct patch panels to deny additional activation of port power if insufficient. Whereas each panel performs power management at its own level, the controller can facilitate power management for and between all connected ports and panels.

These and other objects of the present invention are substantially achieved by providing a device, such as a command module, to manage one or more patch panels having assets and/or PoE and/or power supply features. The command module can query attached patch panels having additional capabilities, synchronize data, and act as an administrative server.

Other objects, advantages and salient features of the present invention will become apparent from the following detailed description, which, when taken in conjunction with the annexed drawings, discloses a preferred embodiment of the present invention.

### BRIEF DESCRIPTION OF THE DRAWINGS

Referring to the drawings which form a part of this disclosure:

FIG. 1 is a block diagram illustrating an exemplary command module in accordance with an embodiment of the present invention;

FIG. 2 is a schematic illustrating an exemplary command module of FIG. 1 in accordance with an embodiment of the present invention;

FIG. 3 is an exploded perspective view of an exemplary command module assembly in accordance with an embodiment of the present invention;

FIGS. 4A-4E are views of the exemplary command module assembly in accordance with an embodiment of the present invention;

FIGS. 5A-5E are views of the exemplary command module case and cover assembly in accordance with an embodiment of the present invention;

FIGS. 6A-6D are views of the exemplary command module case and cover assembly in accordance with an embodiment of the present invention;

FIGS. 7-10 are views illustrating exemplary system connections in accordance with an embodiment of the present invention; and

FIG. 11 is block diagram of an exemplary system in accordance with an embodiment of the present invention.

### DETAILED DESCRIPTION OF THE INVENTION

The present invention includes a system and method for managing a patch panel having additional capabilities, such as a patch panel with asset and/or Power over Ethernet (PoE) and/or power supply features. The invention provides an exemplary system and method for managing a number of patch panels using a communication path and/or protocol, such as a serial communication path/topology or a serial communication protocol. Examples of a serial communication protocol are I2C, RS232, RS485 or similar. Examples of communication paths include a star topology (direct connect) or a daisy chained topology. The invention further provides an exemplary system and method for managing a number of patch panels including an IP network connection and through this Ethernet interface, performing all manner of active management. Embodiments of the present invention can comprise an electrical device, such as a command module, to manage one or more patch panels having assets and/or PoE and/or power supply features. In such a manner, the command module is positioned and adapted to query attached patch panels having such additional capabilities, synchronize data, and act as an administrative server.

Another aspect is that the communication paths/channels can be independent and parallel for each function (e.g. PoE and asset management) for reliability, or can share the same path.

The asset, PoE and power supply, stack management controller (hereinafter referred to as a Command Module), when connected to a panel, such as a PowerTrac panel with an asset and/or a PoE module (i.e. DIMM) installed, can query up to all of the attached panels and synchronize with their data. Once the Command Module and PowerTrac Panel(s) are in synchronization, the Command Module can act as the administrative server and the panels accept the instructions issued by the Command Module as a control policy. For example, when the Command Module is attached to a PowerTrac power supply, the Command Module can administer power management for all attached PowerTrac panels. The Command Module can be connected with the IP network through this Ethernet interface such that all manner of active management is performed.

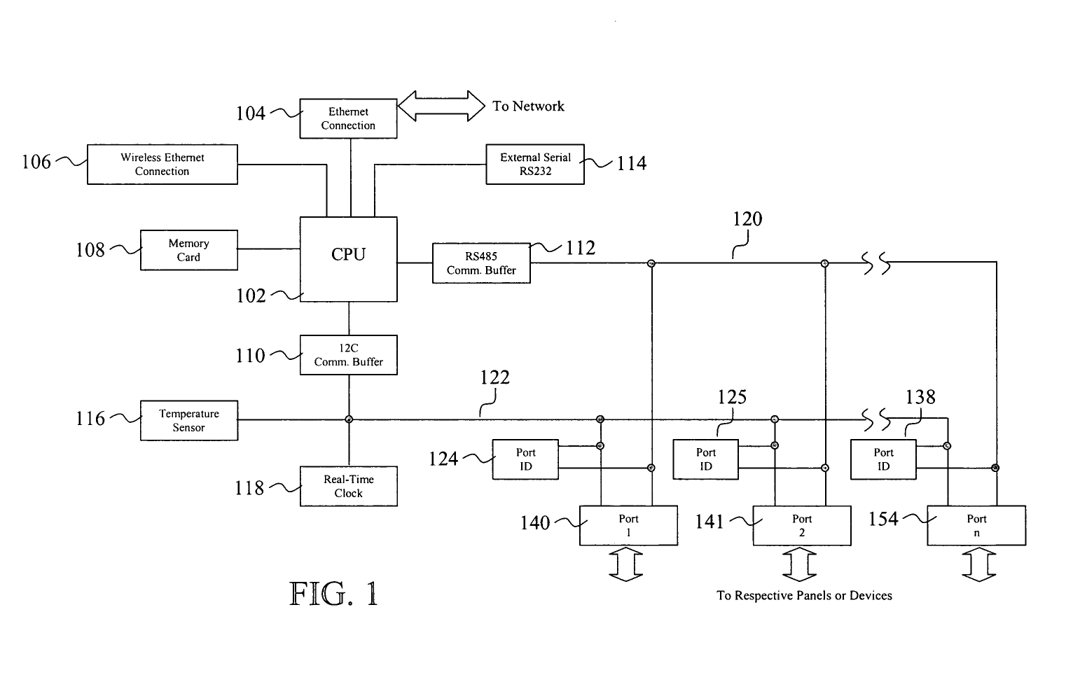

FIG. 1 is a block diagram illustrating an exemplary command module in accordance with an embodiment of the present invention. The command module comprises a central processing unit (CPU) 102 in communication with one or more of a network Ethernet connection 104, a wireless Ethernet connection 106, a memory card 108, a 12C communication buffer 110, and RS485 communication buffer 112, and an external serial RS232 connection 114. One or more of the components, such as the wireless Ethernet connection 104 are optional and can be omitted if desired. In an exemplary embodiment of the present invention, the memory card 108 can be comprised of a Secured Digital (SD) card, but embodiments are not limited thereto.

As shown in FIG. 1, the CPU 102 is in communication with a 12C Bus 122 via the 12C communication buffer 110. The temperature sensor 116 and the real-time clock are also in communication with the 12C Bus 122, which is further coupled to a number of parallel ports 140-154. In an exemplary embodiment of the present invention, up to 15 ports can be coupled in parallel to the 12C Bus 122.

The CPU 102 is also in communication with a 485 Bus 120 via the RS485 communication buffer 120. The 12C Bus and the 485 Bus are each coupled to the ports 140-154. The embodiment shown is but one example, and in yet other embodiments of the present invention, any single or multiple communications bus can be used to either group or isolate functions. That is, in yet other embodiments of the present invention, a single bus or multiple parallel busses can be used. Specifically, depending upon the application, the embodiments of the present invention provide control which can be configured by path, protocol and/or function. For example, one or more communication paths can be used to carry multiple applications, or can be used to carry a single application per path.

Port identification circuits 124-138 can be coupled between the respective Bus connections and provided at each port 140-154. A resistor circuit of each ID circuit 124-138 can be used to provide port identification such that each port is distinguishable by each device at either end. Each port can then be coupled to a patch panel or device for administrative control as described in greater detail below. In doing so, the CPU 102 can be used to direct control and communication functions of attached patch panels and devices via the 485 Bus and the 12C Bus. In an exemplary embodiment of the present invention, the CPU 102 can comprise a mini-computer platform for providing the execution of firmware and functions related to the administration of the attached patch panels and devices via the 485 Bus and the 12C Bus.

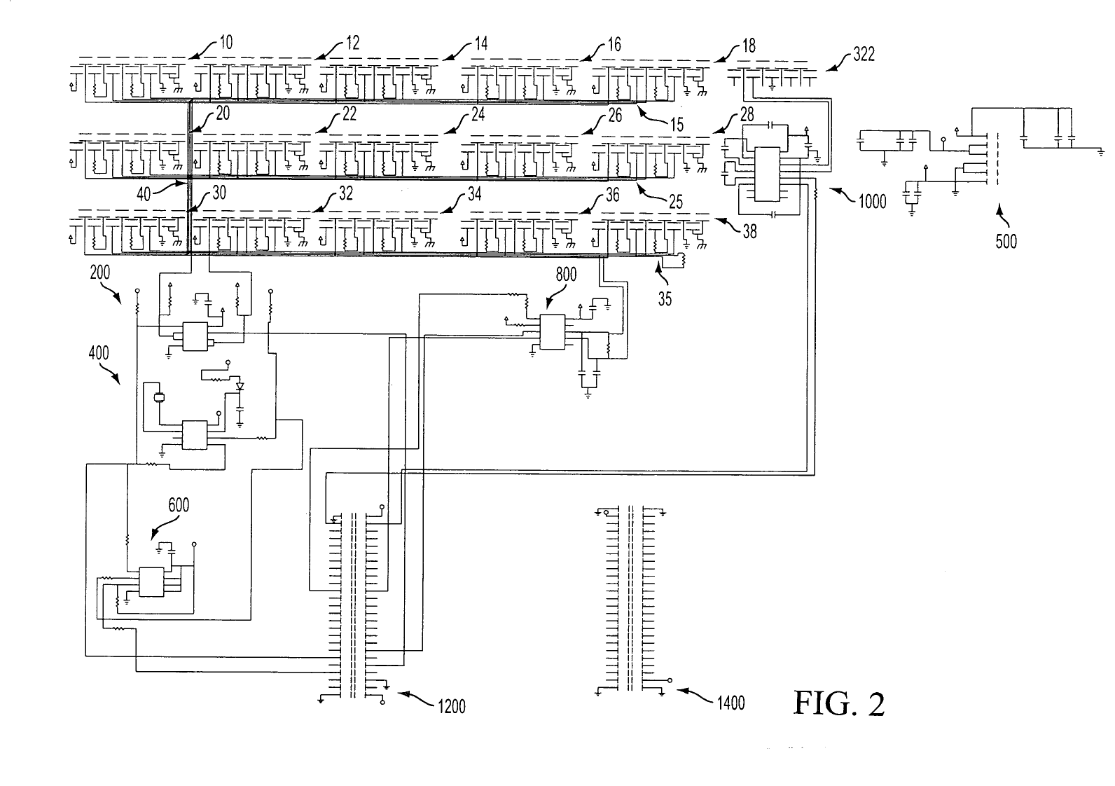

FIG. 2 is a schematic illustrating an exemplary command module of FIG. 1 in accordance with an embodiment of the present invention.

As shown in FIG. 2, the exemplary command module comprises a number of the parallel coupled ports 140-154 of FIG. 1, in this example, shown as RJ connectors 10, 12, 14, 16 and 18. Parallel coupled RJ connectors 20, 22, 24, 26 and 28, and connectors 30, 32, 34, 36 and 38, are provided in a similar manner. In yet other embodiments of the present invention, for example where a communication protocol requiring more pins is used, another suitable connector can be provided in place of the RJ connectors. The parallel 485 Bus 120 and 12C Bus 122 of FIG. 1, in this example, are shown as bus 15 which is provided to parallel couple the RJ connectors 10, 12, 14, 16 and 18, which is then coupled in series with a similar bus 25 and 35.

The command module further comprises the processors of FIG. 1, shown by way of example as ICs 200, 400, 600, 800 and 1000, but embodiments of the present invention are not limited thereto. As shown in FIG. 2, the respective ports are coupled with the IC 200, which is further coupled with the IC 400 and a J connector 1200. The IC 600 is also coupled to the J connector 1200.

The respective ports are also coupled with the IC 800, which is coupled to the J connector 1200. The IC 1000 is also coupled to the J connector 1200, and is further coupled to a connector, illustrated by way of example as a 9 pin D-Sub connector 322, described in greater detail below.

The command module further comprises J connector 1400 and a connector 500. In an exemplary embodiment of the present invention, the J connectors 1200 and 1400 provide a physical connection between the processor sub-assembly 320 and the motherboard 318 described in greater detail below.

The mother board 318 can comprise a number of the communication buffers and so forth, and the processor sub-assembly 320, described in greater detail below, can comprise a number of suitable processors currently available that can be added to the mother board 318.

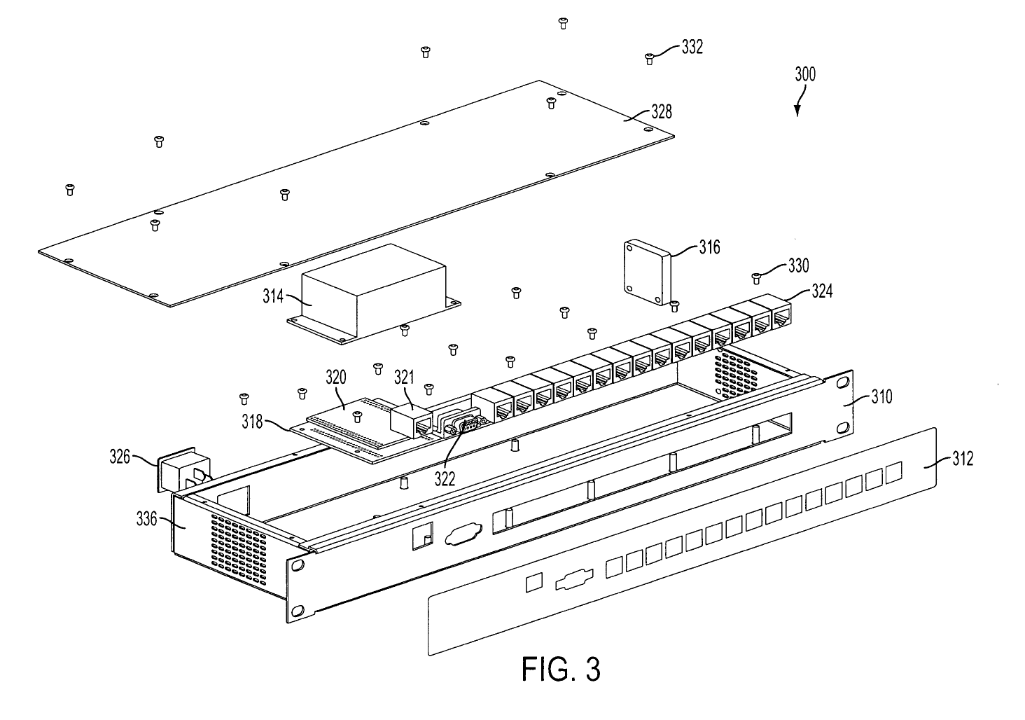

FIG. 3 is an exploded perspective view of an exemplary command module assembly in accordance with an embodiment of the present invention. As shown, the command module assembly can comprise a case 310 upon which a graphic overlay 312 can be provided, and into which a 40 watt power supply 314, a fan 316, and a mother board 318 having a processor 320 (including port 321), the 9 pin D-Sub connector 322, and 10 pin shielded jacks 324 can be placed using a number of screws 330. Further, an inlet 326 and a cover 328, secured using a number of self-threading screws 332, can be provided to complete the command module 300. As shown in FIG. 3, the mother board 318 is provided with the shielded jacks 324 corresponding respectively to the parallel coupled RJ connectors 10-18, 20-28, and 30-38, of FIGS. 1 and 2.

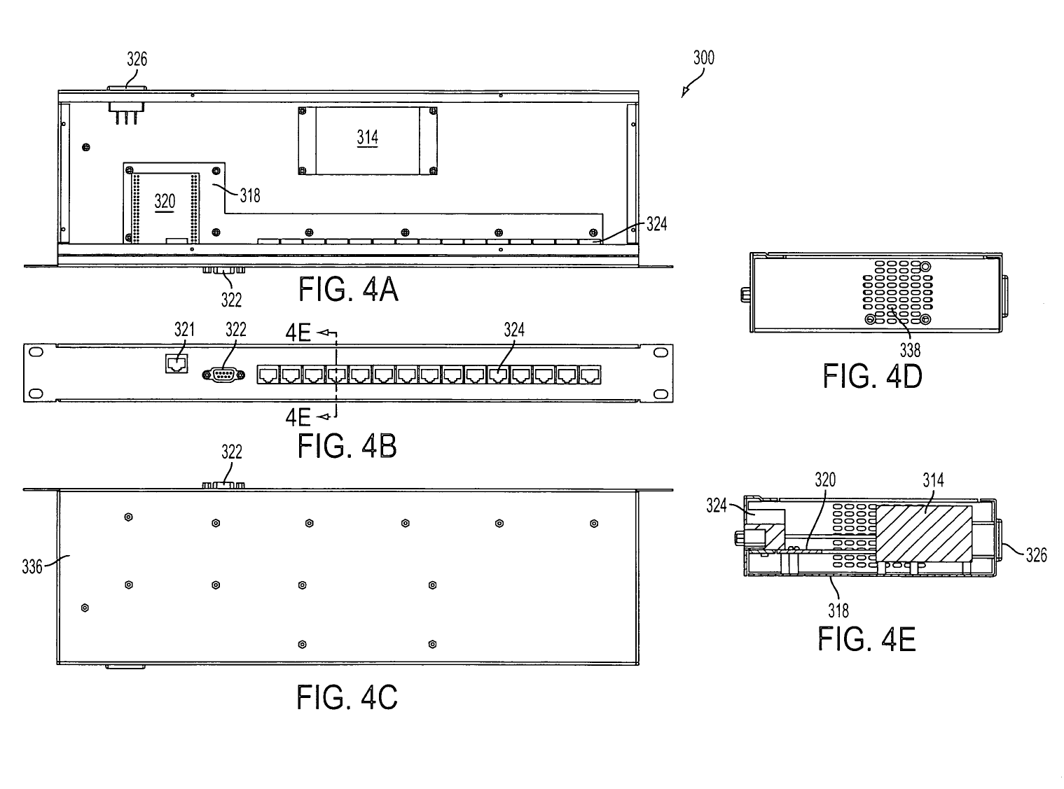

FIGS. 4A to 4E include a top, bottom, front and side view of an exemplary command module 300 assembly in accordance with an embodiment of the present invention. As shown in FIG. 4A, a top view wherein the cover 328 is removed shows exemplary positioning of the assembled power supply 314, mother board 318, processor 320 (i.e. daughter board assembly), 9 pin D-Sub connector 322, 10 pin shielded jacks 324, and inlet 326, within a lower casing 336. The front view of FIG. 4B shows exemplary positioning of the 9 pin D-Sub connector 322, and 10 pin shielded jacks 324, and the bottom view FIG. 4C and side view FIG. 4D shows the complete coverage of the assembled command module 300. FIG. 4E illustrates a cross-section view along line A-A of FIG. 4B, which further illustrates exemplary positioning of the assembled power supply 314, mother board 318, processor 320, 10 pin shielded jacks 324 and inlet 326.

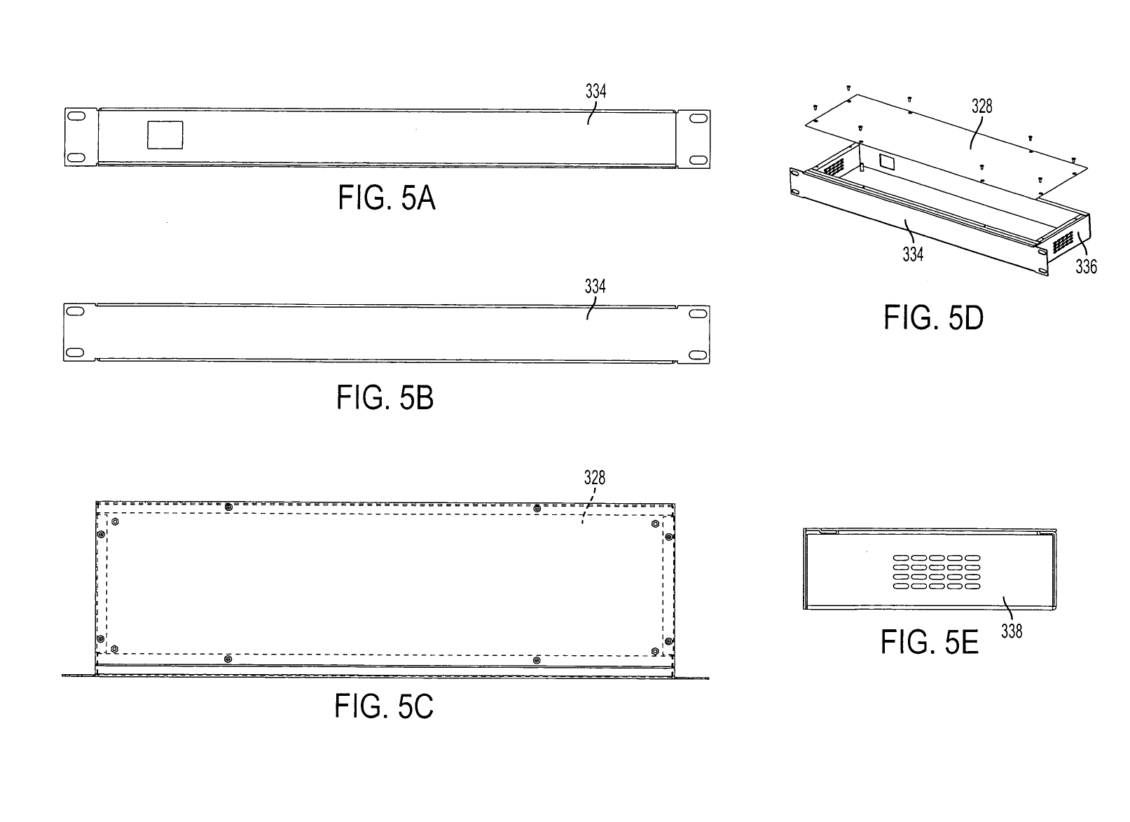

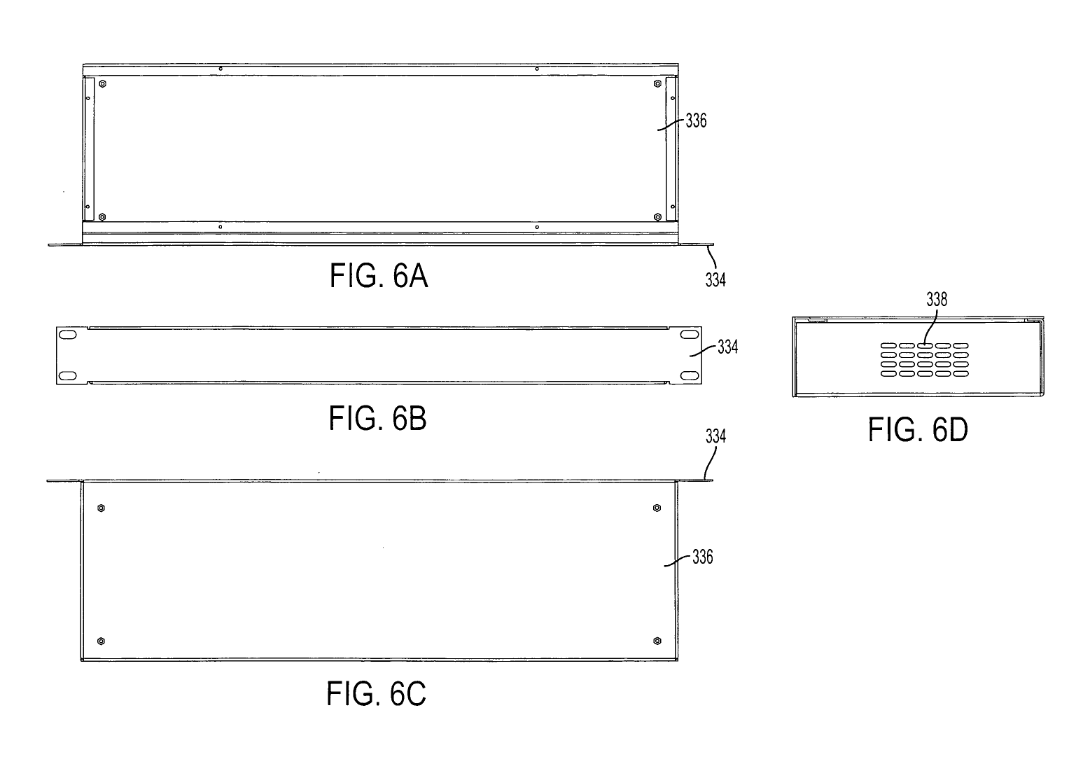

FIGS. 5A-5E include additional views of the exemplary command module case and cover assembly in accordance with an embodiment of the present invention. Specifically, FIGS. 5A-5C show a front, back and assembled view of the front supporting member 334 of the command module 300. Further, FIG. 5E shows exemplary perforation 338 that can be provided at one or both ends of the case and cover assembly. FIGS. 6A-6D are additional views of a command module case and cover assembly in accordance with an embodiment of the present invention.

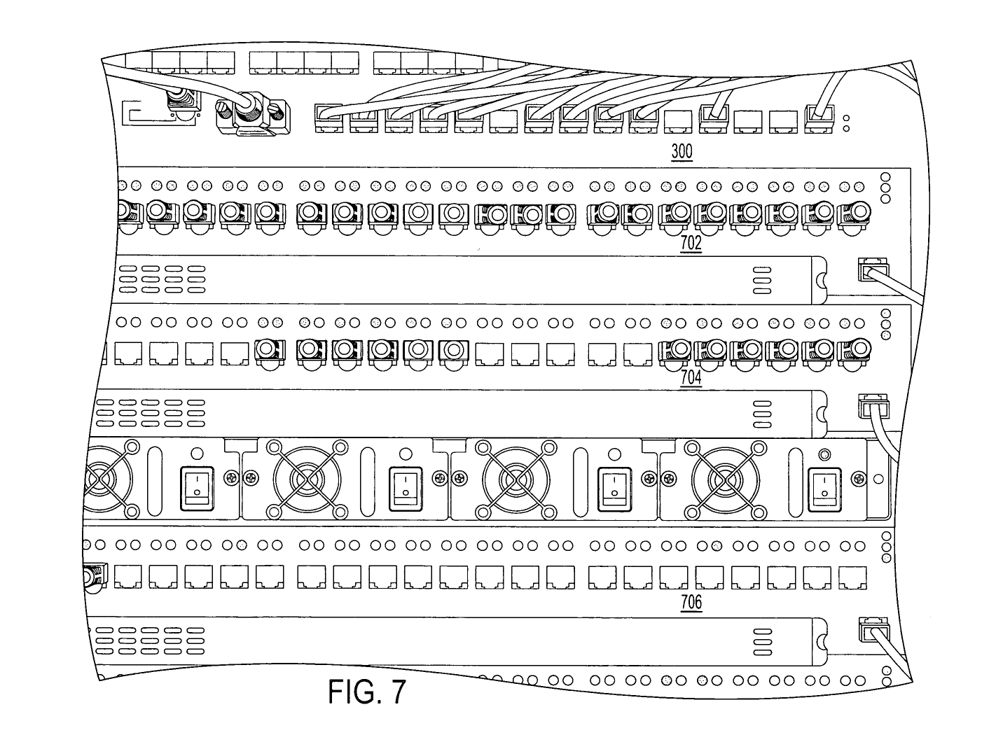

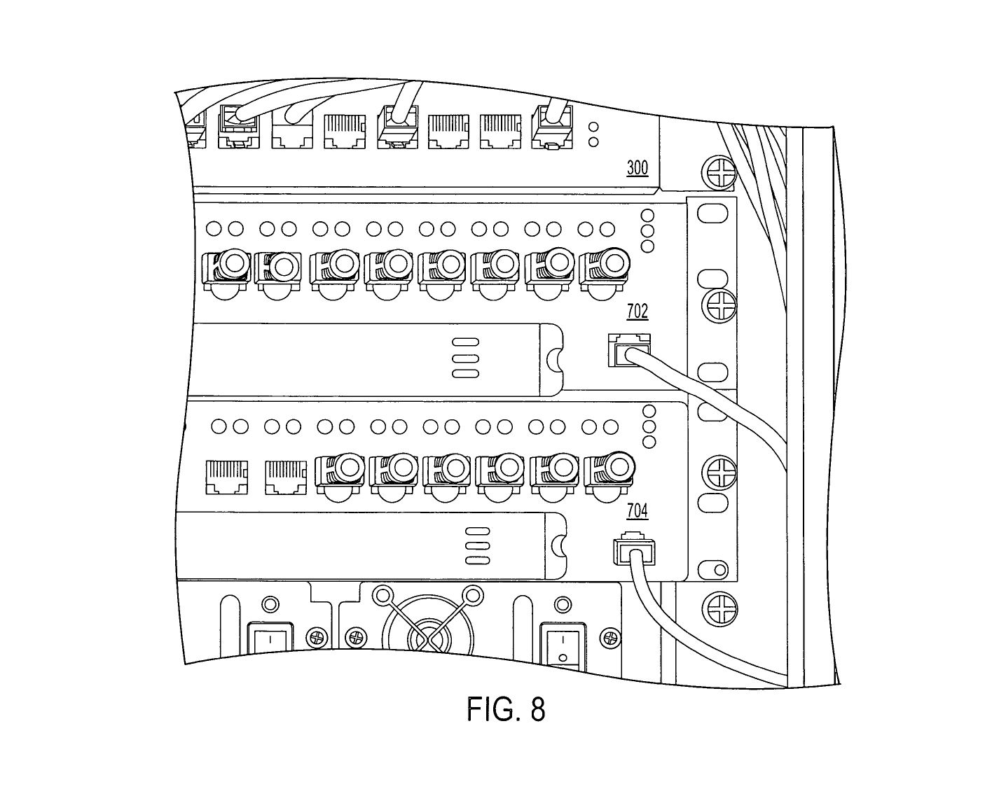

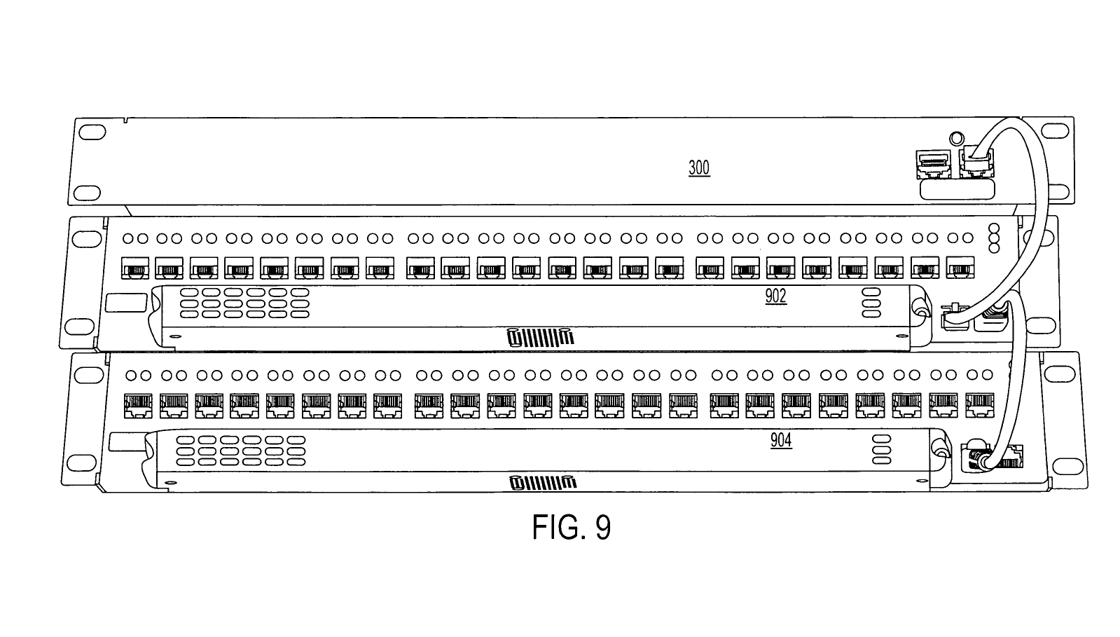

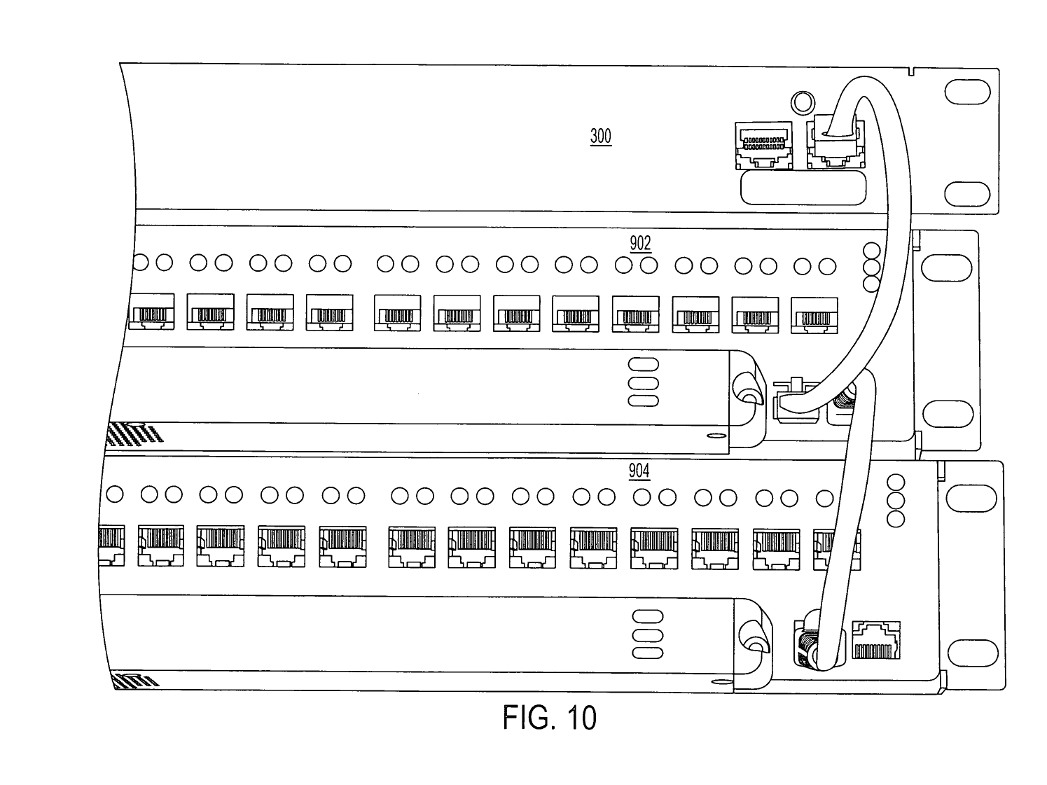

FIGS. 7-8 are views illustrating exemplary direct links in accordance with an embodiment of the present invention, and FIGS. 9-10 are views illustrating exemplary daisy chain links in accordance with an embodiment of the present invention. As noted above, the present invention comprises a command module for managing a patch panel having additional capabilities, such as a patch panel with asset and/or Power over Ethernet (PoE) and/or power supply features. The command module can manage a number of patch panels using a communication path and/or protocol, such as a serial communication protocol (i.e., I2C, RS232, RS484 and the like) or a serial communication path/topology that comprises a star topology (direct connect) or a daisy chained topology. Such a serial communication path comprising a star topology (direct connect) is shown in FIGS. 7 and 8. FIG. 7 is an exemplary arrangement of patch panels in which direct connections of each with the command module are shown, and FIG. 8 shows an enlarged view of the exemplary direct connection of each. The Com Ports 702, 704, 706, . . . n of adjacent patch panels are shown in a direct connection with the command module 300. In doing so, a view of the arrangement from the command module would show the direct connections and can be visualized as a star topology.

FIG. 9 is an exemplary arrangement of patch panels in which daisy chained topology of each connects the patch panels with the command module, and FIG. 10 shows an enlarged view of the exemplary daisy chained topology of each. The Com Ports 902, 904, . . . n of adjacent patch panels are shown in a daisy chained connection with the command module 300. In doing so, a view of the arrangement from the command module would show a direct connection with a first patch panel, and from the first patch panel a direct connection to a second patch panel, and so forth.

As noted above, the asset, PoE and power supply, stack management command module when connected to a panel, such as the PowerTrac panels of FIGS. 7-10 having asset and/or PoE modules installed, can query one or more of the attached panels and synchronize with their data. Once the command module and PowerTrac Panels are in synchronization, the command module can act as the administrative server and the panels are programmed to accept the instructions issued by the command module as a control policy. For example, when the command module is attached to a PowerTrac power supply, the command module can administer power management for all attached PowerTrac panels. The command module can query the power supply and/or determine its available total power, and compare it to power being used in order to perform power management and administration. The command module can then trigger alarms or other indications when certain thresholds of power usage levels are reached. The command module can also instruct patch panels to deny additional activation of port power if insufficient. Whereas each panel performs power management at its own level, the command module can facilitate power management for and between all connected ports and panels.

The command module can be connected with the IP network through this Ethernet interface such that all manner of active management is performed. Further, exemplary embodiments of the present invention can perform control, viewing and setup of functions through a Web Interface, and further include log files that record such events.

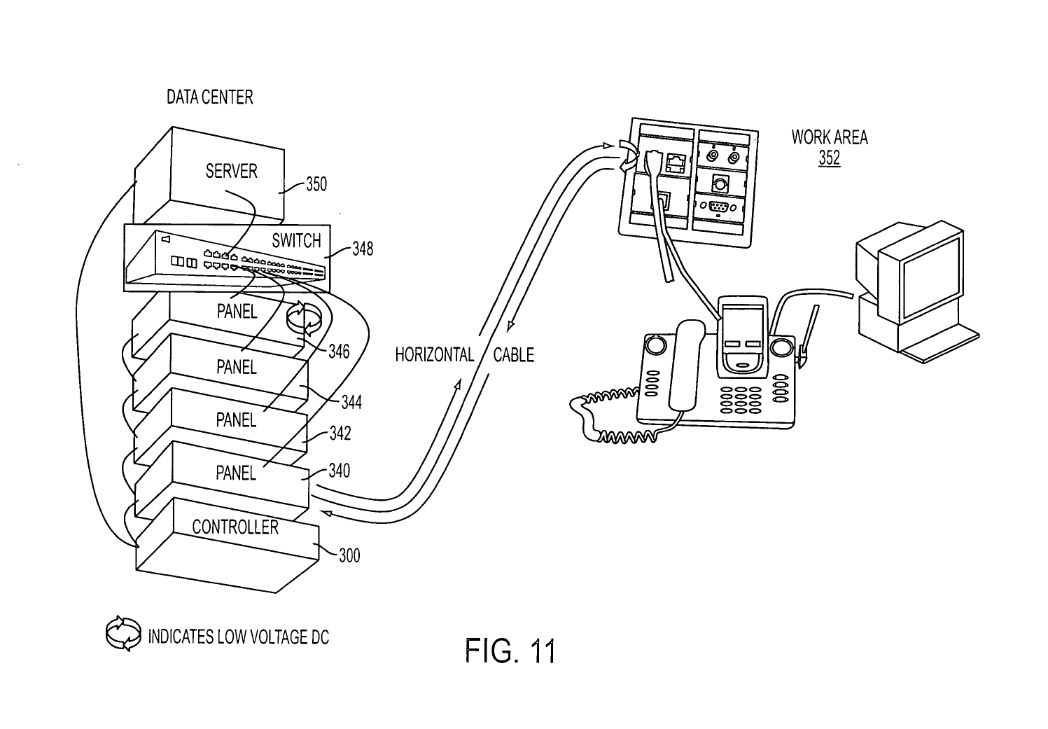

FIG. 11 is an exemplary connectivity block diagram of an exemplary system in accordance with an embodiment of the present invention. As shown in FIG. 11, the command module 300 can be coupled with panels 340, 342, 344 and 346, a switch 348 and a server 350, in addition to a work area 352. The exemplary system and method does not require port mapping, and the controller 300 can be used for asset management and can query attached devices, synchronize data, and act as an administrative server.

Embodiments of the present invention provide an expanded capability of a single controller to manage more than 24-48 ports. This expands the capabilities of active electronics to manage and control 24-48 ports in close proximity to those ports. An exemplary stack manager in accordance with embodiments of the present invention can be provided and can be disposed in the same rack, and in exemplary embodiments of the present invention, can manage up to 360 ports or more. Some functionality can reside at the panel, but preferably, the management resides in the controller.

The patch panels for use with exemplary embodiments of the present invention can include those having advanced feature components provided separately or in combination as either modular plug-in units, such as a dual in-line memory (DIMM), or circuits disposed directly on the patch panel circuit board. The advanced feature components can be used to detect devices attached to the patch panel cabling, both for security and to determine the device types with respect to power requirements, and further provide power to attached devices where practical. Power can be provided through techniques similar to those outlined in IEEE802.3af and TIA-568B series, including updates such as TIA568B.1-6 and other developing standards.

The modular features allow such components to be added and removed in any number of combinations to provide a wide range of desired advanced features to the patch panel, even beyond those outlined above. For example, there are several standards and applications that need power application other than IEEE802.3af, such as building automation systems, security systems, VoIP and so on, and the reference to IEEE802.3af above is presented as one example. Also, the modular features allow for still developing standards, such as those associated with the TIA and IEEE. Additionally, separate modules can be used for providing different functions. For example, separate modules can be provided for power application and for asset management functions. The advanced feature components, however, are not restricted to modular units and can also include fixed circuits or circuit components that are disposed directly on the patch panel or patch panel printed circuit board.

Although only a few exemplary embodiments of the present invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims and their equivalents.

What is claimed is:

1. A command module for managing a patch panel providing one or more advanced features, such as a patch panel with asset or Power over Ethernet (PoE) or power supply features, comprising:
a plurality of connectors for coupling a command module to at least one patch panel;
an Integrated Circuit (IC) adapted to query at least one of the attached patch panels via the connectors, and synchronize the command module with each of the at least one patch panel; and
the IC, once synchronized, further adapted to act as an administrative server for the at least one patch panel.

2. The command module of claim 1, further comprising:
a power supply, wherein the command module is adapted to query the power supply and determine an available total power, and compare it to power being used in order to perform power management.

3. The command module of claim 2, wherein the command module is adapted to perform power management comprising functions to provide an indication when a certain power usage level is reached and instruct the patch panel to deny additional activation of port power.

4. The command module of claim 1, wherein the command module is adapted to communicate with each of the at least one patch panels via at least one of a serial communication protocol and a serial communication path.

5. The command module of claim 4, wherein the command module is coupled directly to each of the at least one patch panels via at least one of a parallel communication path and a serial communication path.

6. The command module of claim 5, wherein the communication paths are configured to be independent and parallel for each of the command module functions.

7. The command module of claim 1, wherein the command module is configured to be connected with an IP network through an Ethernet interface, wherein the command module is adapted to perform active management of the at least one patch panel through the Ethernet interface.

8. The command module of claim 1, wherein the at least one patch panel comprises at least one of an asset management module and a Power over Ethernet module.

9. The command module of claim 1, wherein the command module can be disposed in a same rack as the at least one patch panel.

10. The command module of claim 1, wherein the command module, once synchronized, is further adapted to act as an administrative server to manage up to 360 ports.

11. A method for providing control of at least one patch panel, comprising:
coupling a command module to the at least one patch panel;
querying at least one of the attached patch panels and synchronizing the command module with the data of each;
controlling the command module to act as an administrative server for the at least one patch panel; and
controlling the at least one patch panel to accept instructions issued by the command module as a control policy.

12. The method of claim 11, further comprising:
querying a power supply of the patch panel and determining an available total power, and comparing it to power being used in order to perform power management.

13. The method of claim 12, wherein the power management comprises functions for providing an indication when a certain power usage level is reached and instructing the patch panel to deny additional activation of port power.

14. The method of claim 11, wherein the command module is adapted to communicate with each of the at least one patch panels via at least one of a serial communication protocol and a serial communication path.

15. The method of claim 14, wherein the command module is coupled directly to each of the at least one patch panels via at least one of a parallel communication path and a serial communication path.

16. The method of claim 15, wherein the communication paths are configured to be independent and parallel for each of the command module functions.

17. The method of claim 11, wherein the command module can be connected with an IP network through an Ethernet interface and perform active management of the at least one patch panel through the Ethernet interface.

18. The method of claim 11, wherein the at least one patch panel comprises at least one of an asset management module and a Power over Ethernet module.

19. A command module for managing a patch panel providing one or more advanced features, such as a patch panel with asset or Power over Ethernet (PoE) or power supply features, comprising:
at least one of a network Ethernet connection, a wireless Ethernet connection, a memory card, and an external serial RS232 connection;
